(19) United States
(12) Patent Application Publication
(10) Pub. No.: US 2016/0236332 A1
(43) Pub. Date: Aug. 18, 2016

(54) DRIVING HEAD

(71) Applicants: Huei-Feng Huang, Taichung (TW); Chin-Hsiu Wang, Taichung (TW)

(72) Inventors: Huei-Feng Huang, Taichung (TW); Chin-Hsiu Wang, Taichung (TW)

(21) Appl. No.: 14/622,871

(22) Filed: Feb. 15, 2015

(51) Int. Cl. B25B 15/00; F16B 23/00

(52) U.S. Cl. CPC B25B 15/004; F16B 23/0038; F16B 23/003

(57) ABSTRACT

A driving head includes a body having a connection portion with a polygonal recess, and a driving portion which extends integrally from the connection portion and has a driving section which has multiple engaging faces. The engaging faces are located at equal center angle to each other. A neck is connected between the connection portion and the driving portion. The driving portion is a tapered portion. A first angle is defined between the outer surface of the driving portion and the axis of the body. An object has a reception recess in which the driving section is inserted. The reception recess has a tapered angle. The first angle is smaller than or equal to the tapered angle. The driving portion is strong and is not easily deformed. The driving section is sufficiently engaged with the reception recess of the object.

### BACKGROUND OF THE INVENTION

1. Fields of the Invention

The present invention relates to a driving head, and more particularly, to a driving head having a driving section for holding and driving a screw-type object.

2. Descriptions of Related Art

The conventional driving head for holding and driving a screw-type object is disclosed in FIGS. 9 to 11, and comprises a body 30 which includes a connection portion 31 and a driving portion 32 on two ends thereof. The connection portion 31 has a polygonal recess to be connected with a tool, and the driving portion 32 is a straight shank whose outer surface is parallel with the axis of the driving head. The driving portion 32 has a driving section 321 which has six engaging faces which are located at equal center angle 322 to each other. Each engaging face has two sides, each side is combined with another side of the adjacent engaging face to form an abutment side. The angle 323 between the two abutment sides is 60 degrees. A curved neck 33 is connected between the connection portion 31 and the driving portion 32. As shown in FIGS. 10 and 11, the driving portion 32 is a straight shank which is easily deformed when being applied with teat treatment, this is especially obvious for the length of the body 30 is over 200 mm.

Another conventional driving head is disclosed in U.S. Pat. No. 5,105,690 wherein the driving portion comprises a tapered section and a straight section. Again, the straight section tends to be deformed when being applied with teat treatment. There is a gap between the straight section and the inner periphery of the socket, so that the socket tends to be broken after frequent use.

The present invention intends to provide a driving head to eliminate the shortcomings mentioned above.

### SUMMARY OF THE INVENTION

The present invention relates to a driving head having a driving section for holding and driving a screw-type object, and the driving head comprises a body having a connection portion and a driving portion which extends integrally from the first end of the connection portion. The connection portion has a polygonal recess defined in the second end thereof. The outer diameter of the driving portion is smaller than that of the connection portion. The driving portion has a driving section formed on the distal end thereof, and the driving section has multiple engaging faces defined in the outer periphery thereof. The engaging faces are located at equal center angle to each other. A neck is connected between the connection portion and the driving portion. The neck is a recessed and curved neck. The center of the curvature of the neck is located at outside of the body. The driving portion is a tapered portion. A first angle is defined between the outer surface of the driving portion and the axis of the body. The outer diameter of the driving section is smaller than the outer diameter of the driving portion. An object has a reception recess in which the driving section is inserted. The reception recess has a tapered angle. The first angle is smaller than or equal to the tapered angle. The distal end of the driving section reaches the inner end of the reception recess when the driving section is inserted into the reception recess.

The primary object of the present invention is to provide a driving head wherein the driving portion is strong and is not easily deformed. The driving section is sufficiently engaged with the reception recess of the object.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the driving head of the present invention;

FIG. 2 is a front view of the driving head of the present invention;

FIG. 3 is a cross sectional view, taken along line B-B in FIG. 2;

FIG. 4 is an enlarged view of the circled portion C in FIG. 2;

FIG. 5 is an end view to show the polygonal recess of the connection portion of the driving head of the present invention;

FIG. 6 is a cross sectional view to show that the driving head of the present invention is engaged with the object;

FIG. 7 is an enlarged view of the circled portion D in FIG. 6;

FIG. 8 is a perspective view to show the second embodiment of the driving head of the present invention;

FIG. 9 is a front view of a conventional driving head;

FIG. 10 is a cross sectional view, taken along line B-B in FIG. 9, and

FIG. 11 is an enlarged view of the circled portion C in FIG. 9.

### DETAILED DESCRIPTION OF THE PREFERRED EMBODIMENT

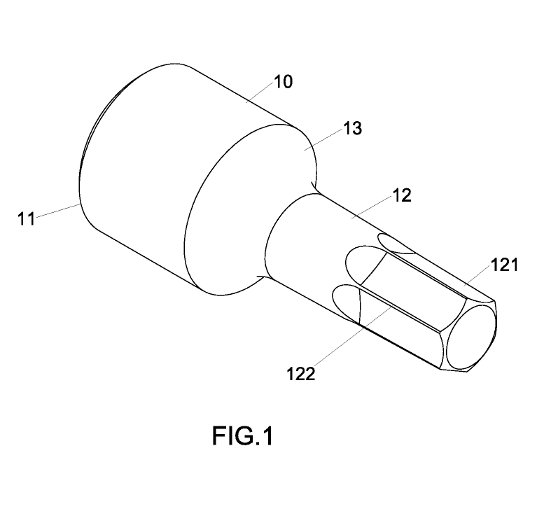

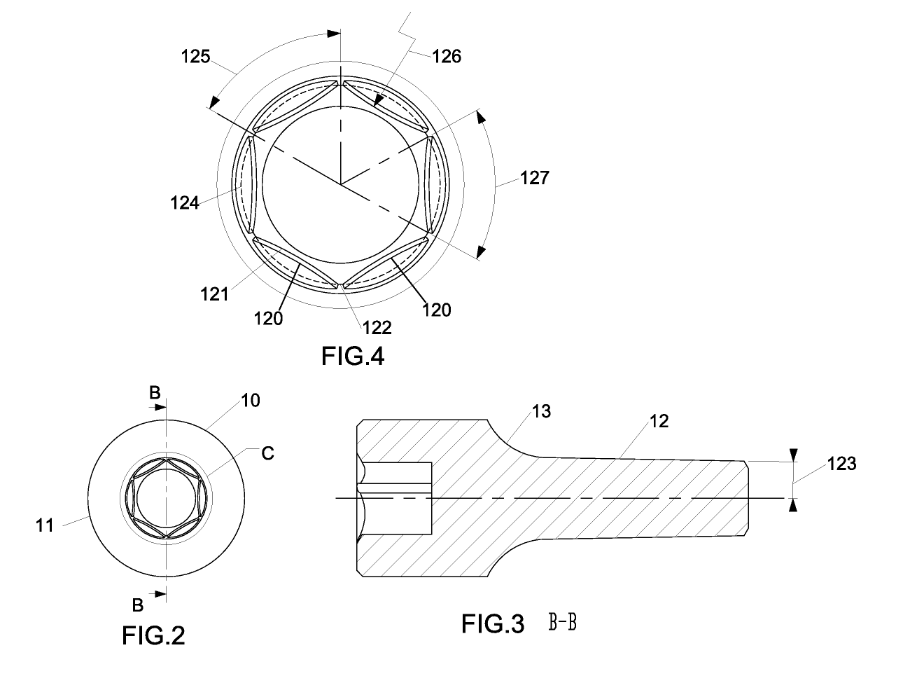

Referring to FIGS. 1 to 4, the driving head having a driving section for holding and driving a screw-type object, of the present invention comprises a body 10 having a connection portion 11 and a driving portion 12 which extends integrally from the first end of the connection portion 11. The connection portion 11 has a polygonal recess 110 defined in the second end thereof so as to be connected with a tool which is not shown. The polygonal recess 110 is a rectangular recess. The outer diameter of the driving portion 12 is smaller than the outer diameter of the connection portion 11. The driving portion 12 has a driving section 121 formed on the distal end thereof. The driving section 121 has six engaging faces 120 defined in the outer periphery thereof. The engaging faces 120 are located at equal center angle to each other around the central axis of the body 10. A neck 13 is connected between the connection portion 11 and the driving portion 12. The neck 13 is a recessed and curved neck. The center of the curvature of the neck 13 is located at outside of the body 10S. An imaginary circSpecificationle 124 is formed at the distal end of the driving section 121. Each engaging face 120 has a radius 126. Each engaging face 120 is a recessed face and has two sides, the center angle of each engaging face 120 is 0.9 to 0.98 times of 60 degrees. Preferably, the center angle of each engaging face 120 is 0.9 to 0.95 times of 60 degrees. There is a curved face 122 formed between the two adjacent sides of two adjacent engaging faces 120.

The driving portion 12 is a tapered portion. A first angle 123 is defined between the outer surface of the driving portion 12 and the axis of the body 10. The outer diameter of the driving section 121 is smaller than the outer diameter of the driving portion 12.

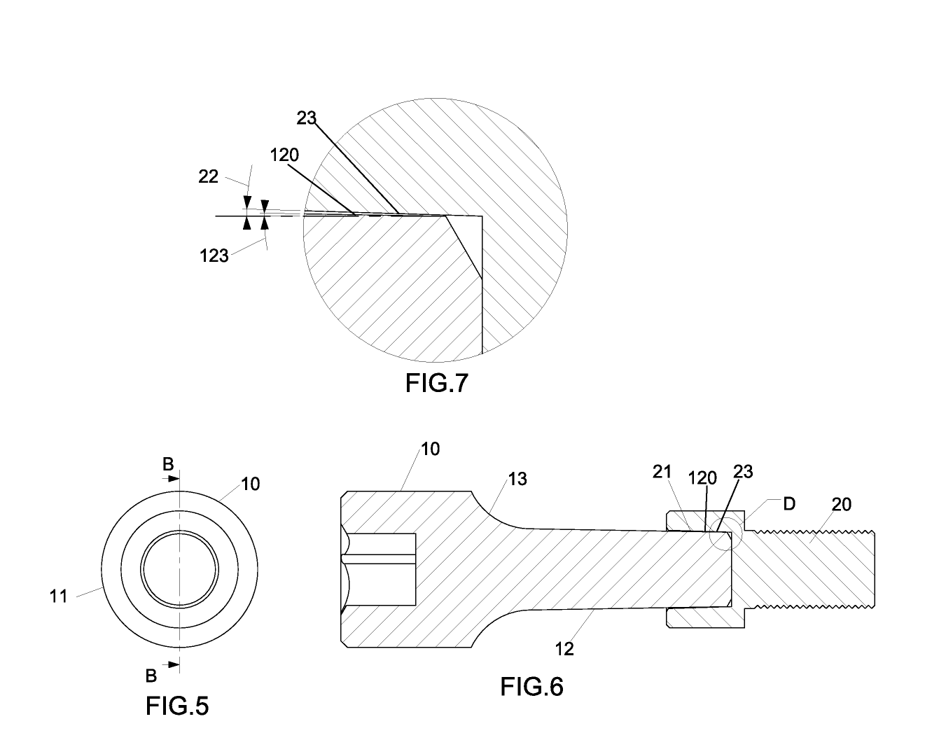

As shown in FIGS. 5, 6 and 7, an object 20 has a reception recess 21 in which the driving section 121 is inserted. The reception recess 21 has a tapered angle 22, and the first angle 123 is smaller than or equal to the tapered angle 22. The distal end of the driving section 121 reaches the inner end of the reception recess 21 when the driving section 121 is inserted into the reception recess 21.

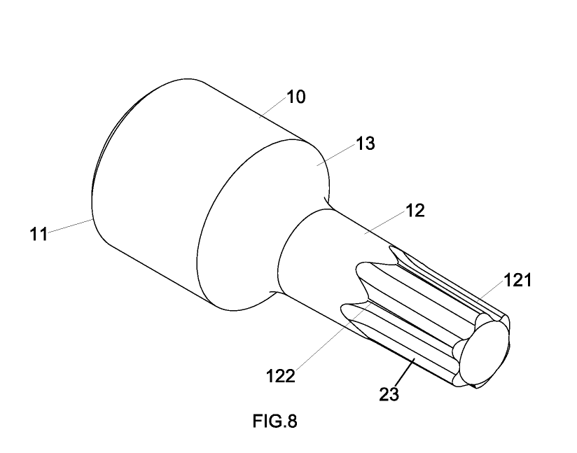

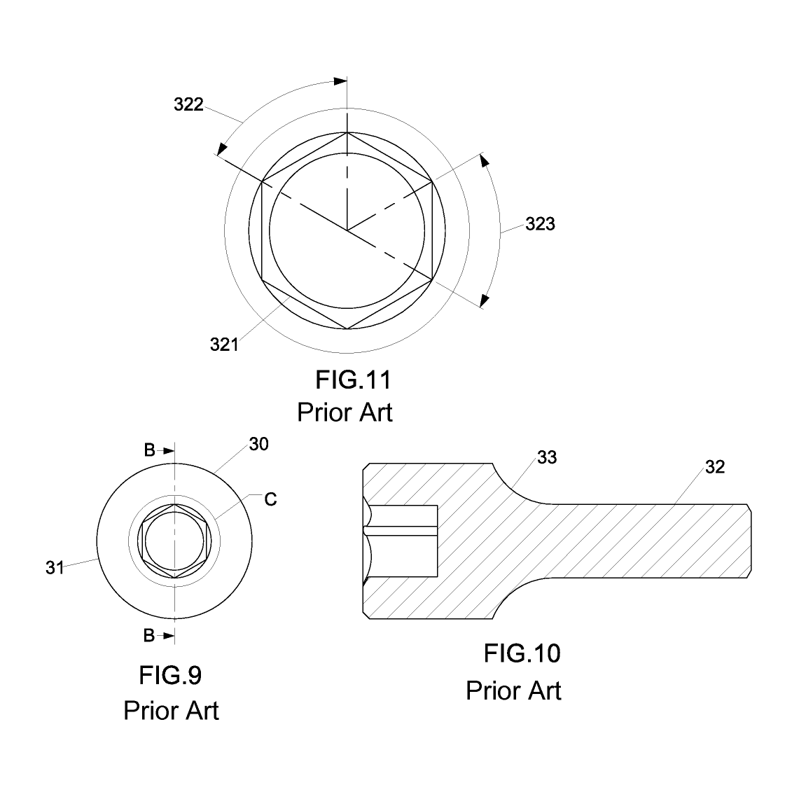

As shown in FIG. 8 which shows the second embodiment and a gear-like shape is seen when viewed from the end of the driving section 121.

The characters of the present invention are that the driving portion 12 is a tapered portion wherein the diameter of the driving portion 12 gradually reduces from the connection portion with the neck 13 toward the driving section 121. The reception recess 21 has a tapered angle 22, and the first angle 123 is smaller than or equal to the tapered angle 22. When the driving section 121 is inserted into the reception recess 21, because the first angle 123 is smaller than or equal to the tapered angle 22, the distal end of the driving section 121 reaches the inner end of the reception recess 21.

It is noted that the tapered driving portion 12 is a tapered portion so that it is not deformed when being applied with heat treatment. Furthermore, because the first angle 123 is smaller than or equal to the tapered angle 22, when the driving section 121 is inserted into the reception recess 21, the distal end of the driving section 121 reaches the inner end of the reception recess 21. Therefore, the reception recess 21 is not broken during operation.

While we have shown and described the embodiment in accordance with the present invention, it should be clear to those skilled in the art that further embodiments may be made without departing from the scope of the present invention.

What is claimed is:

1. A driving head having a driving section for holding and driving a screw-type object, comprising:
a body having a connection portion and a driving portion which extends integrally from a first end of the connection portion, the connection portion having a polygonal recess defined in a second end thereof, an outer diameter of the driving portion being smaller than an outer diameter of the connection portion, the driving portion having a driving section formed on a distal end thereof, the driving section having multiple engaging faces defined in an outer periphery thereof, the engaging faces located at equal center angle to each other, a neck connected between the connection portion and the driving portion, the neck being a recessed and curved neck, a center of a curvature of the neck located at outside of the body, the driving portion being a tapered portion, a first angle defined between an outer surface of the driving portion and an axis of the body, an outer diameter of the driving section being smaller than the outer diameter of the driving portion, and
an object having a reception recess in which the driving section is inserted, the reception recess having a tapered angle, the first angle being smaller than or equal to the tapered angle, a distal end of the driving section reaching an inner end of the reception recess when the driving section is inserted into the reception recess.

2. The driving head as claimed in claim 1, wherein there are six engaging faces formed in the outer periphery of the driving section, the six engaging faces are in equal central angle around the central axle of the body, each engaging face is a recessed face and has two sides, the center angle of each engaging face is 0.9 to 0.98 times of 60 degrees.

3. The driving head as claimed in claim 1, wherein there are six engaging faces formed in the outer periphery of the driving section, the six engaging faces are in equal central angle around the central axle of the body, each engaging face is a recessed face and has two sides, the center angle of each engaging face is 0.9 to 0.95 times of 60 degrees.

4. The driving head as claimed in claim 1, wherein the driving section is a gear-like shape viewed from the end of the driving section.
